(19) United States
(12) Patent Application Publication
(10) Pub. No.: US 2016/0328338 A1
(43) Pub. Date: Nov. 10, 2016

(54) SIGNAL SWITCHING CIRCUIT AND JBOD SYSTEM HAVING THE SIGNAL SWITCHING CIRCUIT

(71) Applicants: HONG FU JIN PRECISION INDUSTRY (ShenZhen) CO., LTD., Shenzhen (CN); HON HAI PRECISION INDUSTRY CO., LTD., New Tapiei (TW)

(72) Inventor: Jin-Shan Ma, Shenzhen (CN)

(21) Appl. No.: 14/805,005

(22) Filed: Jul. 21, 2015

(30) Foreign Application Priority Data
May 8, 2015 (CN) 201510231702.5

(51) Int. Cl. G06F 13/16

(52) U.S. Cl. CPC G06F 13/16

(57) ABSTRACT

A signal switching circuit for a system of Just a Bunch of Disks includes a first connector, a second connector, and first gate module. The first connector is coupled to a server and the second connector is coupled to an external device. The server communicates with the Bunch of Disks (BOD) through the first connector and the external device communicates with the BOD through the second connector. When the external device is coupled to the second connector, a control signal is outputted from the second connector. The first gate module receives the control signal and outputs data signals outputted from the first connector or from the second connector according to the control signal. A system of Just a Bunch of Disks is also included.

### FIELD

The subject matter herein generally relates to just a bunch of disks (JBOD) systems and particularly to a JBOD system having a signal switching circuit.

### BACKGROUND

An RJ45 connector is needed between a JBOD and a server for communication. A DB9 connector is needed between an external device, such as a computer, and the JBOD when the JBOD is broken down. A mutual interference is generated between signal transmitted by the RJ45 connector and signal transmitted by the DB9 connector.

### BRIEF DESCRIPTION OF THE DRAWINGS

Implementations of the present technology will now be described, by way of example only, with reference to the attached figures.

FIG. 1 is a block diagram of an example embodiment of a JBOD system, the JBOD system comprising a signal switching circuit and a JBOD.

FIG. 2 is a block diagram of an example embodiment of the signal switching circuit of FIG. 1, the signal switching circuit comprising a first connector, a second connector, a conversion module, a first gate module, a second gate module, and a control module.

FIG. 3 is a circuit diagram of the first connector, the second connector, and the conversion module of FIG. 2.

FIG. 4 is a circuit diagram of the first gate module, the second gate module, and the control module of FIG. 2, the second gate module electrically coupled to the JBOD.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a systematic collection of disks as just a bunch of disks (JBOD) system 1000.

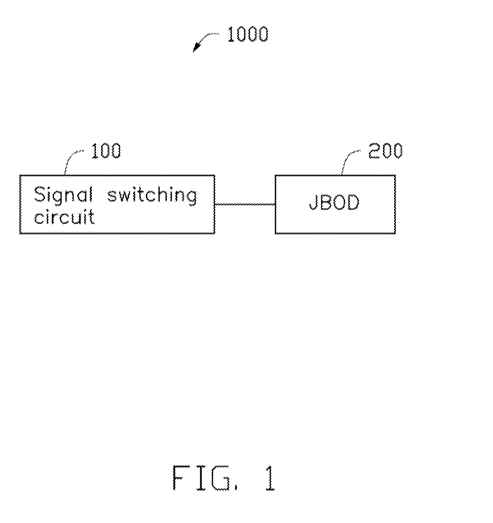

FIG. 1 illustrates an embodiment of a JBOD system 1000. The JBOD system 1000 can comprise a signal switching circuit 100 and a JBOD 200.

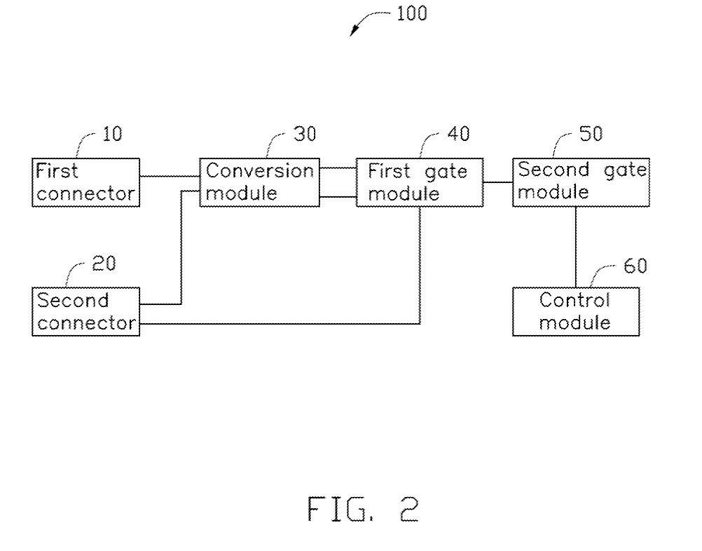

FIG. 2 illustrates an embodiment of the signal switching circuit 100. The signal switching circuit 100 can comprise a first connector 10, a second connector 20, a conversion module 30, a first gate module 40, a second gate module 50, and a control module 60. The conversion module 30 is electrically coupled to the first connector 10, the second connector 20, and the first gate module 40. The first gate module 40 is further electrically coupled to the second connector 20 and the second gate module 50. The second gate module 50 is further electrically coupled to the control module 60.

In at least one embodiment, the first connector 10 is configured to be electrically coupled to a server for communication. The second connector 20 is configured to be electrically coupled to an external device, such as a computer, for communication.

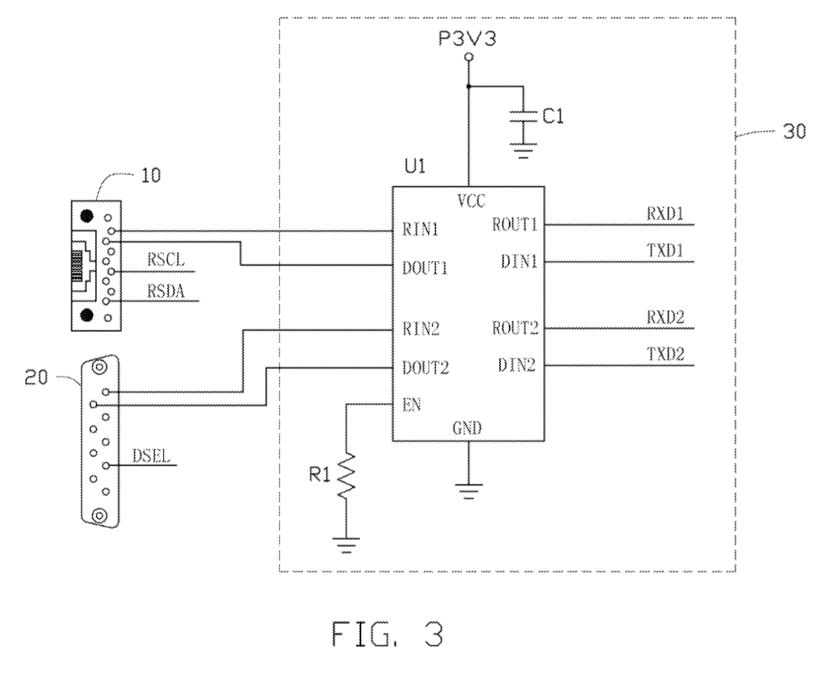

FIG. 3 illustrates an embodiment of the first connector 10, the second connector 20, and the conversion module 30. In at least one embodiment, the first connector 10 is an RJ45 connector and the second connector 20 is a DB9 connector.

The conversion module 30 can comprise a conversion chip U1, a resistor R1, and a capacitor C1. A power pin VCC of the conversion chip U1 is coupled to a power supply P3V3. The power pin VCC of the conversion chip U1 is also coupled to ground through the capacitor C1. An enable pin EN of the conversion chip U1 is coupled to ground through the resistor R1. A first set of input pins, RIN1 and DOUT1, of the conversion chip U1 are coupled to the first connector 10. A second set of input pins, RIN2 and DOUT2, of the conversion chip U1 are coupled to the second connector 20. The conversion chip U1 is configured to switch voltage level of data signals received by the first set of input pins RIN1, DOUT1 and by the second set of input pins RIN2, DOUT2. A first set of output pins ROUT1, DIN1 and a second set of output pins ROUT2, DIN2 of the conversion chip U1 are coupled to the first gate module 40. In at least one embodiment, voltage levels of data signals outputted by the RJ45 connector and the DB9 connector comply with RS232 standard, and the conversion chip U1 is configured to switch the voltage levels of the data signals from RS232 standard to CMOS standard, and then output the data signals through the first set of output pins ROUT1, DIN1 and the second set of output pins ROUT2, DIN2.

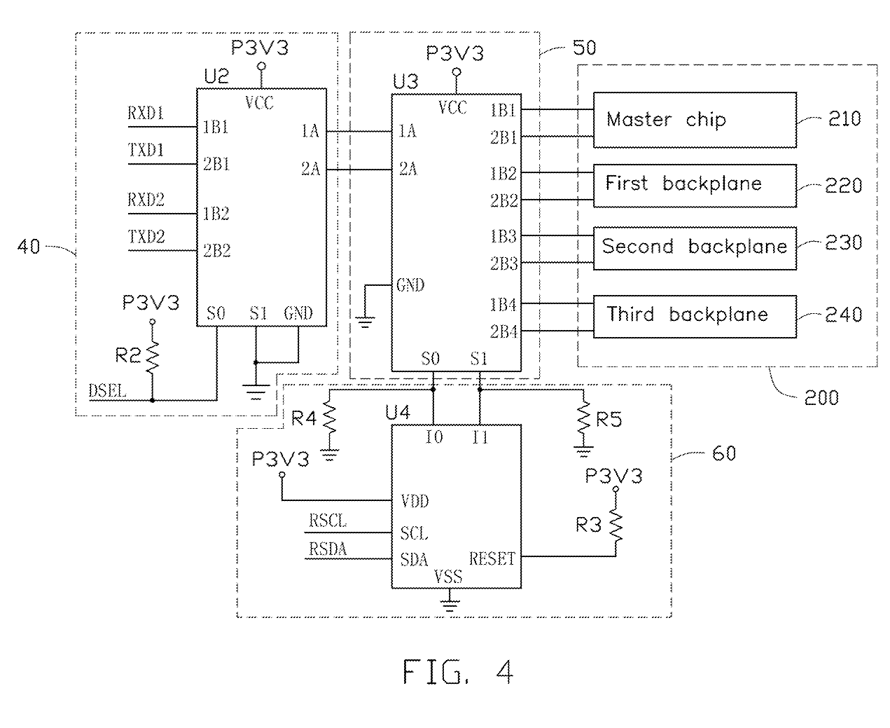

FIG. 4 illustrates an embodiment of the first gate module 40, the second gate module 50, and the control module 60. The first gate module 40 can comprise a first gate chip U2 and a pull-up resistor R2. A power pin VCC of the first gate chip U2 is coupled to the power supply P3V3. A first select pin S0 of the first gate chip U2 is coupled to the power supply P3V3 through the pull-up resistor R2. The first select pin S0 of the first gate chip U2 is also coupled to a select pin of the second connector 20. A low level signal is outputted from the select pin of the second connector 20 when the external device is coupled to the second connector 20. A second select pin S1 of the first gate chip U2 and the ground pin GND of the first gate chip U2 are coupled to ground. A first set of input pins 1B1, 2B1 and a second set of input pins 1B2, 2B2 of the first gate chip U2 are respectively coupled to the first set of output pins ROUT1, DIN1 and the second set of output pins ROUT2, DIN2. Two output pins 1A, 2A of the first gate chip U2 are coupled to the second gate module 50.

The second gate module 50 can comprise a second gate chip U3. A power pin VCC of the second gate chip U3 is coupled to the power supply P3V3. A ground pin GND of the second gate chip U3 is coupled to ground. Input pins 1A, 2A of the second gate chip U3 are respectively coupled to the output pins 1A, 2A of the first gate chip U2. A first select pin S0 and a second select pin S1 of the second gate chip U3 are coupled to the control module 60. Output pins of the second gate chip U3 are coupled to the JBOD 200. In at least one embodiment, the JBOD 200 can comprise a master chip 210 and first to third backplanes, 220, 230, and 240. A first set of output pins 1B1 and 2B1 of the second gate chip U3 are electrically coupled to the master chip 210. A second set of output pins 1B2 and 2B2 of the second gate chip U3 are electrically coupled to the first backplane 220. A third set of output pins 1B3 and 2B3 of the second gate chip U3 are electrically coupled to the second backplane 230. A fourth set of output pins 1B4 and 2B4 of the second gate chip U3 are electrically coupled to the third backplane 240.

The control module 60 can comprise a control chip U4 and resistors R3-R5. A power pin VDD of the control chip U4 is coupled to the power supply P3V3. A ground pin VSS of the control chip U4 is coupled to ground. A reset pin RESET of the control chip U4 is coupled to the power supply P3V3 through the resistor R3. Two input pins SCL, SDA of the control chip U4 are coupled to control pins of the first connector 10. A first output pin IO of the control chip U4 is coupled to the first select pin S0 of the second gate chip U3 and coupled to ground through the resistor R4. A second output pin I1 of the control chip U4 is coupled to the second select pin S1 of the second gate chip U3 and coupled to ground through the resistor R5.

When the server is coupled to the first connector 10 and the external device is not coupled to the second connector 20, the first set of input pins RIN1, DOUT1 of the conversion chip U1 receives data signals from the first connector 10, the conversion chip U1 switches the voltage level of data signals and then outputs switched data signals to the first set of input pins 1B1, 2B1 of the first gate chip U2, through the first set of output pins ROUT1, DIN1. The first select pin S0 of the first gate chip U2 receives a high level signal and the output pins 1A, 2A of the second gate chip U2 output the signals received by the first set of input pins 1B1, 2B1 to the input pins 1A, 2A of the second gate chip U3.

At the same time, each of the input pins SCL, SDA of the control chip U4 receives a control signal from the first connector 10. The first and second output pins I0, I1 of the control chip U4 are respectively outputting low level select signals and high level select signals to the first select pin S0 and the second select pin S1 of the second gate chip U3. The second gate chip U3 controls the input pins 1A, 2A to be electrically coupled to one of the first to fourth sets of output pins, 1B1 and 2B1, 1B2 and 2B2, 1B3 and 2B3, or 1B4 and 2B4 to achieve communication between the server and the JBOD 200. For example, when the first and second select pins S0, S1 of the second gate chip U3 respectively output a low level signal, the input pins 1A, 2A of the second gate chip U3 are coupled to the first set of output pins 1B1, 2B1, and the server coupled to the first connector 10 communicates with the master chip 210 of the JBOD 200.

When the JBOD 200 is not working and the external device is coupled to the second connector 20, the second set of input pins RIN2, DOUT2 of the conversion chip U1 receive data signals from the second connector 20. The conversion chip U1 switches the voltage level of data signals and then outputs switched data signals to the second set of input pins 1B2, 2B2 of the first gate chip U2 through the second set of output pins ROUT2, DIN2. The first select pin S0 of the first gate chip U2 receives a low level signal and the output pins 1A, 2A of the second gate chip U2 output the signals received by the second set of input pins 1B2, 2B2. The second gate chip U3 receives the select signals and controls the input pins 1A, 2A to be coupled to one of the first to fourth sets of output pins, 1B1 and 2B1, 1B2 and 2B2, 1B3 and 2B3, or 1B4 and 2B4 for achieving communication between the external device and the JBOD 200.

The embodiment shown and described above is only example. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A signal switching circuit comprising:
a first connector configured to be coupled to a server, the server communicated with a just a bunch of disks (JBOD) through the first connector;
a second connector configured to be coupled to an external device, the external device communicated to the JBOD through the second connector, wherein a control signal is outputted from the second connector when the external device is coupled to the second connector; and
a first gate module coupled to the first and the second connectors, wherein the first gate module outputs data signals from the first connector or the second connector according to the control signal.

2. The signal switching circuit of claim 1, wherein the first gate module comprises a first gate chip and a pull-up resistor, a first select pin of the first gate chip is coupled to a power supply through the pull-up resistor, and coupled to the second connector to receive the control signal; when the external device is not coupled to the second connector, the control signal received by the first select pin of the first gate chip is at high level, and the first gate chip output the data signals from the first connector;
when the external device is coupled to the second connector, the control signal received by the first select pin of the first gate chip is at low level, and the first gate chip output the data signals from the second connector.

3. The signal switching circuit of claim 1, further comprising a conversion module, wherein the first connector and the second connector are coupled to the first gate module through the conversion module, the conversion module switches a voltage level of the data signals received from the first connector and the second connector.

4. The signal switching circuit of claim 3, wherein the first connector is an RJ45 connector and the second connector is a DB9 connector.

5. The signal switching circuit of claim 4, wherein the conversion module comprise a conversion chip configured to switch the voltage level of the data signals outputted from the RJ45 connector and the DB9 connector from RS232 standard to CMOS standard then output the data signals.

6. The signal switching circuit of claim 1, further comprising a second gate module and a control module, wherein the second gate module is coupled between the first gate module and the JBOD, the JBOD comprises a master chip and a plurality of backplanes, the control module is coupled to the second gate module and configured to control the second gate module to couple the first gate module to the master chip or one of the backplanes

7. The signal switching circuit of claim 6, wherein the control module comprises a control chip, input pins of the control chip are coupled to control pins of the first connector to receive a control signal from the first connector, first and second output pins of the control chip output low level select signals or high level select signals respectively to the second gate module.

8. A just a bunch of disks (JBOD) system comprising:
a master chip;
a plurality of backplanes; and
a signal switching circuit comprising:
a first connector configured to be coupled to a server, the server communicated to the master chip and the backplane through the first connector;
a second connector configured to be coupled to an external device, the external device communicated to the master chip and the backplane through the second connector, wherein when the external device is coupled to the second connector, a control signal is outputted from the second connector;
a first gate module coupled to the first and the second connectors and receive data signals from the first and the second connectors, wherein the first gate module is configured to output the data signals outputted from the first connector or the second connector according to the control signal;
a second gate module coupled between the first gate module and the master chip and the backplane; and
a control module coupled to the second gate module and configured to control the second gate module states for achieving communication between the first gate module and the master chip or the backplane.

9. The JBOD system of claim 8, wherein the first gate module comprises a first gate chip and a pull-up resistor, a first select pin of the first gate chip is coupled to a power supply through the pull-up resistor, and coupled to the second connector to receive the control signal; when the external device is not coupled to the second connector, the control signal received by the first select pin of the first gate chip is at high level, and the first gate chip output the data signals from the first connector; when the external device is coupled to the second connector, the control signal received by the first select pin of the first gate chip is at low level, and the first gate chip output the data signals from the second connector.

10. The JBOD system of claim 9, wherein the control module comprises a control chip, input pins of the control chip are coupled to control pins of the first connector to receive a control signal from the first connector, first and second output pins of the control chip output low level select signals or high level select signals respectively to the second gate module.
